(19) United States
(12) Patent Application Publication
(10) Pub. No.: US 2024/0205709 A1
(43) Pub. Date: Jun. 20, 2024

(54) COMMON FREQUENCY RESOURCE, CONTROL RESOURCE SET CONFIGURATIONS, AND COMMON FREQUENCY RESOURCE SWITCHING

(71) Applicant: Nokia Technologies Oy, Espoo (FI)

(72) Inventors: Naizheng ZHENG, Beijing (CN); David NAVRÁTIL, Espoo (FI); Athul PRASAD, Naperville, IL (US); Ugur Baran ELMALI, Munich (DE); Volker PAULI, Munich (DE); David BHATOOLAUL, Swindon (GB); Jarkko Tuomo KOSKELA, Oulu (FI)

(21) Appl. No.: 18/553,380

(22) PCT Filed: May 12, 2021
(86) PCT No.: PCT/CN2021/093229

§ 371 Date: Sep. 29, 2023

(51) Int. Cl. H04W 24/08; H04W 72/0453; H04W 72/0457; H04W 72/30; H04W 76/20

(52) U.S. Cl. CPC H04W 24/08; H04W 72/0453; H04W 72/0457; H04W 72/30; H04W 76/20

(57) ABSTRACT

Systems, methods, apparatuses, and computer program products for common frequency resource, control resource set configurations, and common frequency resource switching. The method may include receiving, from a network element, a configuration for monitoring at least one broadcast services on a communication resource. The method may also include monitoring the at least one broadcast service on the communication resource based on the configuration. According to certain example embodiments, the communication resource may be a subset of an initial bandwidth part, or the communication resource may include an initial bandwidth part as a subset of the communication resource.

### FIELD

Some example embodiments may generally relate to mobile or wireless telecommunication systems, such as Long Term Evolution (LTE) or fifth generation (5G) radio access technology or new radio (NR) access technology, or other communications systems. For example, certain example embodiments may relate to apparatuses, systems, and/or methods for common frequency resource, control resource set configurations, and common frequency resource switching.

### BACKGROUND

Examples of mobile or wireless telecommunication systems may include the Universal Mobile Telecommunications System (UMTS) Terrestrial Radio Access Network (UTRAN), Long Term Evolution (LTE) Evolved UTRAN (E-UTRAN), LTE-Advanced (LTE-A), MulteFire, LTE-A Pro, and/or fifth generation (5G) radio access technology or new radio (NR) access technology. Fifth generation (5G) wireless systems refer to the next generation (NG) of radio systems and network architecture. 5G network technology is mostly based on new radio (NR) technology, but the 5G (or NG) network can also build on E-UTRAN radio. It is estimated that NR will provide bitrates on the order of 10-20 Gbit/s or higher, and will support at least enhanced mobile broadband (eMBB) and ultra-reliable low-latency-communication (URLLC) as well as massive machine type communication (mMTC). NR is expected to deliver extreme broadband and ultra-robust, low latency connectivity and massive networking to support the Internet of Things (IoT). With IoT and machine-to-machine (M2M) communication becoming more widespread, there will be a growing need for networks that meet the needs of lower power, low data rate, and long battery life. It is noted that, in 5G, the nodes that can provide radio access functionality to a user equipment (i.e., similar to Node B in UTRAN or eNB in LTE) are named gNB when built on NR technology and named NG-eNB when built on E-UTRAN radio.

### SUMMARY

Some example embodiments may be directed to a method. The method may include receiving, from a network element, a configuration for monitoring at least one broadcast service on a communication resource. The method may also include monitoring the at least one broadcast service on the communication resource based on the configuration. According to certain example embodiments, the communication resource may be a subset of an initial bandwidth part, or the communication resource may include an initial bandwidth part as a subset of the communication resource.

Other example embodiments may be directed to an apparatus. The apparatus may include at least one processor and at least one memory including computer program code. The at least one memory and computer program code may also be configured to, with the at least one processor, cause the apparatus at least to receive, from a network element, a configuration for monitoring at least one broadcast service on a communication resource. The apparatus may also be caused to monitor the at least one broadcast service on the communication resource based on the configuration. According to certain example embodiments, the communication resource may be a subset of an initial bandwidth part, or the communication resource may include an initial bandwidth part as a subset of the communication resource.

Other example embodiments may be directed to an apparatus. The apparatus may include means for receiving, from a network element, a configuration for monitoring at least one broadcast service on a communication resource. The apparatus may also include means for monitoring the at least one broadcast service on the communication resource based on the configuration. According to certain example embodiments, the communication resource may be a subset of an initial bandwidth part, or the communication resource may include an initial bandwidth part as a subset of the communication resource.

In accordance with other example embodiments, a non-transitory computer readable medium may be encoded with instructions that may, when executed in hardware, perform a method. The method may include receiving, from a network element, a configuration for monitoring at least one broadcast service on a communication resource. The method may also include monitoring the at least one broadcast service on the communication resource based on the configuration. According to certain example embodiments, the communication resource may be a subset of an initial bandwidth part, or the communication resource may include an initial bandwidth part as a subset of the communication resource.

Other example embodiments may be directed to a computer program product that performs a method. The method may include receiving, from a network element, a configuration for monitoring at least one broadcast service on a communication resource. The method may also include monitoring the at least one broadcast service on the communication resource based on the configuration. According to certain example embodiments, the communication resource may be a subset of an initial bandwidth part, or the communication resource may include an initial bandwidth part as a subset of the communication resource.

Other example embodiments may be directed to an apparatus that may include circuitry configured to receive, from a network element, a configuration for monitoring at least one broadcast service on a communication resource. The apparatus may also include circuitry configured to monitor the at least one broadcast service on the communication resource based on the configuration. According to certain example embodiments, the communication resource may be a subset of an initial bandwidth part, or the communication resource may include an initial bandwidth part as a subset of the communication resource.

Certain example embodiments may be directed to a method. The method may include configuring a user equipment to monitor at least one broadcast service on a communication resource. According to other example embodiments, the communication resource may be a subset of an initial bandwidth part, or the communication resource may include an initial bandwidth part as a subset of the communication resource.

Other example embodiments may be directed to an apparatus. The apparatus may include at least one processor and at least one memory including computer program code. The at least one memory and computer program code may be configured to, with the at least one processor, cause the apparatus at least to configure a user equipment to monitor at least one broadcast service on a communication resource. According to other example embodiments, the communication resource may be a subset of an initial bandwidth part, or the communication resource may include an initial bandwidth part as a subset of the communication resource.

Other example embodiments may be directed to an apparatus. The apparatus may include means for configuring a user equipment to monitor at least one broadcast service on a communication resource. According to other example embodiments, the communication resource may be a subset of an initial bandwidth part, or the communication resource may include an initial bandwidth part as a subset of the communication resource.

In accordance with other example embodiments, a non-transitory computer readable medium may be encoded with instructions that may, when executed in hardware, perform a method. The method may include configuring a user equipment to monitor at least one broadcast service on a communication resource. According to other example embodiments, the communication resource may be a subset of an initial bandwidth part, or the communication resource may include an initial bandwidth part as a subset of the communication resource.

Other example embodiments may be directed to a computer program product that performs a method. The method may include configuring a user equipment to monitor at least one broadcast service on a communication resource. According to other example embodiments, the communication resource may be a subset of an initial bandwidth part, or the communication resource may include an initial bandwidth part as a subset of the communication resource.

Other example embodiments may be directed to an apparatus that may include circuitry configured to configure a user equipment to monitor at least one broadcast service on a communication resource. According to other example embodiments, the communication resource may be a subset of an initial bandwidth part, or the communication resource may include an initial bandwidth part as a subset of the communication resource.

### BRIEF DESCRIPTION OF THE DRAWINGS

For proper understanding of example embodiments, reference should be made to the accompanying drawings, wherein:

FIG. 1 illustrates an example of common frequency resource (CFR) cases A, B, C, D, and E, according to certain example embodiments.

FIG. 2 illustrates an example CFR for multicast control channel (MCCH) and multicast transport channel (MTCH), according to certain example embodiments.

FIG. 3 illustrates an example of a gNB configuration of separated/different CFR for multiple MCCH(s) and MTCH(s), according to certain example embodiments.

FIG. 4 illustrates example CFR confined within an initial bandwidth part (BWP), according to certain example embodiments.

FIG. 5 illustrates an example narrow CFR bandwidth operation at a certain time stamp, according to certain example embodiments.

FIG. 6 illustrates the CFR configured within an initial BWP, according to certain example embodiments.

FIG. 7 illustrates an initial BWP confined within the CFR with larger bandwidth, according to certain example embodiments.

FIG. 8 illustrates an example bandwidth switch to narrow initial BWP, according to certain example embodiments.

FIG. 9 illustrates an example flow diagram of another method, according to certain example embodiments.

FIG. 10 illustrates an example flow diagram of a further method, according to certain example embodiments.

FIG. 11(a) illustrates an apparatus, according to certain example embodiments.

FIG. 11(b) illustrates another apparatus, according to certain example embodiments.

### DETAILED DESCRIPTION

It will be readily understood that the components of certain example embodiments, as generally described and illustrated in the figures herein, may be arranged and designed in a wide variety of different configurations. The following is a detailed description of some example embodiments of systems, methods, apparatuses, and computer program products for common frequency resource and control resource set configurations, and common frequency resource switching.

The features, structures, or characteristics of example embodiments described throughout this specification may be combined in any suitable manner in one or more example embodiments. For example, the usage of the phrases “certain embodiments,” “an example embodiment,” “some embodiments,” or other similar language, throughout this specification refers to the fact that a particular feature, structure, or characteristic described in connection with an embodiment may be included in at least one embodiment. Thus, appearances of the phrases “in certain embodiments,” “an example embodiment,” “in some embodiments,” “in other embodiments,” or other similar language, throughout this specification do not necessarily refer to the same group of embodiments, and the described features, structures, or characteristics may be combined in any suitable manner in one or more example embodiments.

3rd Generation Partnership Project (3GPP) defines common frequency resource (CFR) for radio resource control (RRC) user equipment in idle and inactive states, and a corresponding control resource set (CORESET) configuration for RRC_IDLE/INACTIVE UEs to receive broadcast services. For RRC_IDLE/INACTIVE UEs, CFR(s) for group-common physical downlink control channel/physical downlink shared channel (PDCCH/PDSCH) have been defined/configured. Here CFRs may imply a common set of frequency resources/physical resource blocks where the multicast or broadcast control and data channel traffic is scheduled by the network. In this case, the UE may assume that an initial bandwidth part (BWP) is the default CFR for the group-common PDCCH/PDSCH if a specific CFR is not configured. Initial BWP may be the set of frequency resources used by the UE for initial access before a radio resource control connection is established with the network. Further, the initial BWP may be monitored by idle/inactive mode UEs for receiving various information—such as paging, multicast or broadcast, from the network. In other cases, for RRC_IDLE/INACTIVE UEs, a CORESET—dedicated to multicast/broadcast, may be configured within the CFR for group-common PDCCH/PDSCH. Here, CORESET #0 may be used by default if the CFR for group-common PDCCH/PDSCH is the initial BWP and the CORESET is not configured.

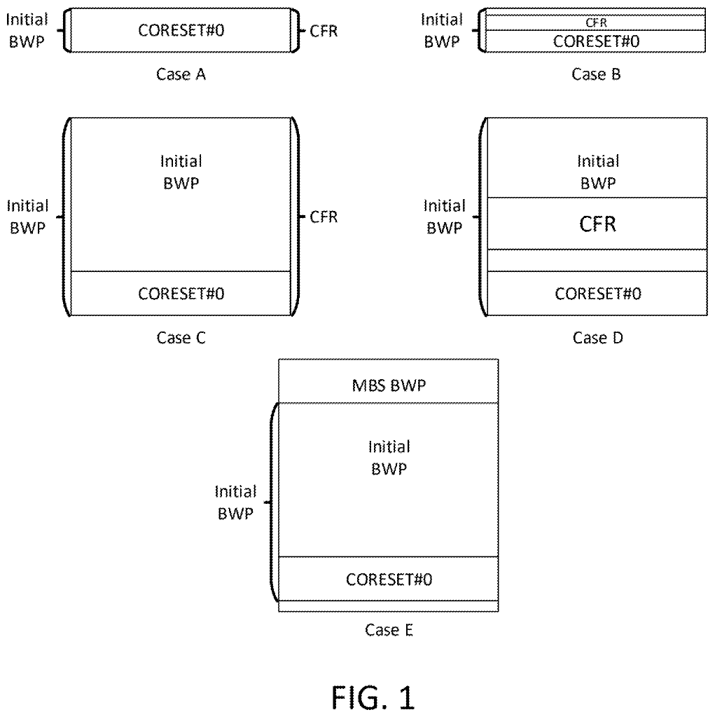

Regarding the CFR(s) configuration for RRC_IDLE/INACTIVE UEs, for broadcast reception, there may be cases of a configured/defined specific CFR for the group-common PDCCH/PDSCH. For instance, in a Case E (e.g., FIG. 1), a CFR may be defined based on a configured BWP, and it may be determined whether a configured BWP for multicast broadcast service (MBS) is needed, and whether BWP switching is needed. Furthermore, the configured BWP in Case E may have several properties including, for example, having frequency resources larger than the frequency resources of the initial BWP. In addition, the CFR may have frequency resources that are identical to the configured BWP. Furthermore, the configured BWP may fully include the initial BWP in the frequency domain, and may have the same subcarrier spacing (SCS) and cyclic prefix (CP) as the initial BWP.

In the case where the initial BWP fully includes the CFR in the frequency domain, several sub-cases may be considered. For instance, in a Case B (e.g., FIG. 1) where the size of a CFR is smaller than an initial BWP, the initial BWP may have the same frequency resources as CORESETO. In this case, the CFR may have the frequency resources confined within the initial BWP, and have the same SCS and CP as the initial BWP. However, in a Case D (e.g., FIG. 1), the CFR may be smaller in size than the initial BWP, and the initial BWP may have frequency resources configured by SIB1. In this case, the CFR may have the frequency resources confined within the initial BWP, and have the same SCS and CP as the initial BWP.

3GPP also describes cases where the initial BWP may be the same size as the CFR in the frequency domain. For instance, in a Case A (e.g., FIG. 1), a CFR may have the same size as the initial BWP, and the initial BWP may have the same frequency resource as CORESETO. In this case, the CFR may have the same frequency resources and the same SCS and CP as the initial BWP. In another case, Case C (e.g., FIG. 1), the CFR may have the same size as the initial BWP, where the initial BWP has the same frequency resources configured by SIB1. In this case, the CFR may have the same frequency resources and the same SCS and CP as the initial BWP.

As described in 3GPP TS38.306, the UE may have certain capabilities with parameter multipleCORESET, which may indicate whether the UE supports a configuration of more than one or up to two PDCCH CORESETs per BWP in addition to the CORESET with CORESET-ID 0 in the BWP. If this is not supported, the UE may support one PDCCH CORESET per BWP in addition to the CORESET with CORESET-ID 0 in the BWP. As such, this may suggest that the UEs may support two CORESETs (CORESET #0+Additional CORESET, where the Additional CORESET is configured by commonControlResourceSet) per BWP and the support of three CORESETs (CORESET #0+Additional-2-CORESETs) may be an optional UE capability. In some cases, a maximum five CORESETS (CORESET #0+Additional-4-CORESETs) may be an optional capability for the UEs.

FIG. 1 illustrates an example of CFR cases A, B, C, D, and E, according to certain example embodiments. Case A illustrates an example where the CFR is identical to the initial BWP, as well as to CORESET #0 by considering the default CORESET #0 as the initial BWP. This case may also be seen as a CFR default case where CORESET #0 is initially utilized for group-common PDCCH/PDSCH transmission (for multicast control channel/multicast transport channel (MCCH/MTCH)). Here the logical channels—MCCH/MTCH may also be mapped to PDSCH.

Case B in the example of FIG. 1 illustrates a case where the CFR is smaller than the CORESET #0. By considering the large coverage need to be served by broadcast/multicast in a cell, the limited number of control channel elements (CCEs) within the CFR size smaller than CORESET #0 may be questionable to provide enough coverage. For Case C, the CFR may be identical to the initial BWP, and CORESET #0 may be confined within the SIB1 configured initial BWP. This case may be considered as a default case, for instance, if the additional CFR frequency-range configuration is not included. Furthermore, considering if the payload size of MCCH/MTCH is smaller than paging/open system interconnection model/re-authorization request (OSI/RAR) and a more frequent need to be transmitted and monitored, different SS monitoring periodicity may be configured for MBS services.

For Case D, the CFR may be smaller than the initial BWP, and CORESET #0 may be confined within the SIB1 configured initial BWP. This case may be seen as a special case of Case C, where with inclusion of additional CFR frequency-range configuration is smaller than the initial BWP. If the configured CFR frequency-range configuration is the same as the initial BWP, then it may be identical to the default Case C. Furthermore, considering if the payload size of MCCH/MTCH is smaller than paging/OSI/RAR, and also a more frequent need to be monitored, different SS monitoring periodicity may be configured for MBS services. For Case E, a separate MBS BWP may be configured. Such configuration may be beneficial when large data payload with MBS services need to be transmitted with a larger bandwidth than the initial BWP can handle.

In certain examples, the CFR CORESET design for RRC_IDLE/INACTIVE UEs to receive MBS services may depend on the CFR that is defined. As such, certain example embodiments provide a method that addresses the open CORESET issues. For instance, certain example embodiments provide a way for the CORESET for MBS services for RRC_IDLE/INACTIVE UEs to be configured to support different CFR cases (e.g., Case A, C, D, and/or E). Certain example embodiments also provide a way to handle switching between a BWP and CFR(s). Moreover, certain example embodiments may consider the CFR configuration for MCCH and MTCH, which may be configured differently as well as it may be the same CFR for both MCCH and MTCH.

Certain example embodiments may be based on different CFR configuration cases (e.g., Case A/C/D/E), and may provide how the CORESET for MBS services for RRC_IDLE/INACTIVE UEs may be configured. For instance, as illustrated in the example of FIG. 1, in Case A, the group-common PDCCH/PDSCH for MBS services may be expected to be monitored and received via CORESET #0. A new search-space (SS) monitoring occasion (MO) configuration(s) may be provided to the RRC_IDLE/INACTIVE UEs receiving MBS services (e.g., via MBS SIB or MCCH). In this example, CORESET #0 may include different SSs for different UEs. This may avoid legacy UEs and UEs that are not interested in MBS services to frequently monitor CORESET #0 PDCCH, saving power. In addition, the new SS MO may be configured corresponding to different MBS services, and it does not necessarily have to be one such configuration for all MBS.

With regard to Case C in the example of FIG. 1, the group-common PDCCH/PDSCH for MBS services may be monitored and received via CFR that is identical to the initial BWP. Here, NR broadcast services may be configured and monitored by the UEs in RRC_IDLE/INACTIVE state both in the CORESET #0 and CORESET configured via commonControlResourceSet, where each CORESET may be associated with certain MBS-service(s). In other words, different MBS services may be configured in different CORESETs. For instance, in certain example embodiments, Group-common Radio Network Temporary Identifier-1 (G-RNTI-1) may be associated with CORESET #0 and G-RNTI-2&3 may be associated with CORESET via commonControlResourceSet. Here G-RNTI may be configured by the network to the UE to identify a particular MBS service. The downlink control information (DCI) or control channel/scheduling information for a particular MBS service may be scrambled using G-RNTI, which enables the UE to understand that the scheduling information corresponds to the related MBS service. If a UE is interested in MBS services, then the UE may monitor both MBS services from CORESET #0 and CORESET of commonControlResourceSet. Otherwise, the CORESET that includes the MBS service(s) that the UE is interested is monitored.

According to certain example embodiments, the CORESET may be mapped with a certain broadcast service that can be made in terms of mbsSearchSpace configuration in the CORESET that may be configured via MBS SIB or MCCH. Further, a searchSpaceId (that is mapped to one of the mbsSearchSpace(s)) may be included in one or more group radio network temporary identifier(s) (G-RNTI(s)) configuration, or a different searchSpaceId may be associated with different G-RNTI configuration. Thus, different MBS services may share a search space, or have separate search spaces.

In certain example embodiments, for CORESET #0 and CORESET via commonControlResourceSet, a new search-space (SS) monitoring occasion (MO) configuration(s) may be provided to the RRC_IDLE/INACTIVE UEs receiving MBS services (e.g., via MBS SIB or MCCH). In doing so, the CORESET #0 and CORESET via commonControlResourceSet may include different SSs for different UEs. In addition, it may be possible to avoid legacy UEs and UEs that are not interested in MBS services to frequently monitor CORESET #0 PDCCH, and save power. In some example embodiments, one or more new SS MO may be configured corresponding to different MBS services. That is, according to certain example embodiments, there may not need to be just one SS MO configured for multiple MBS services.

With regard to Case D in the example of FIG. 1, the group-common PDCCH/PDSCH for MBS services may be expected to be monitored and received via a smaller CFR that may be configured within the initial BWP. For instance, in this case, a new/additional CFR_CORESET (in addition to CORESET #0 and CORESET via commonControlResourceSet) may be configured within the CFR (e.g., via MBS SIB or MCCH configuration). For instance, according to certain example embodiments, NR broadcast services may be configured and monitored by the UE both in the CORESET #0 and CFR_CORESET depending on the broadcast service types where CORESET may be associated with certain MBS-service(s). According to other example embodiments, dependent on the UE capability, the UE may operate at the narrow CFR at a certain time stamp, where the switching by the UE from the initial BWP to the bandwidth of a narrow CFR_CORESET or CFR may be transparent to the gNB.

According to further example embodiments, with regard to Case D in the example of FIG. 1, and based on the UE capability, there may be more than one PDCCH CORESET per BWP in addition to the CORESET #0 in the initial BWP (e.g., that are configured via MBS SIB or MCCH configuration). For instance, according to certain example embodiments, the MBS-UE monitored CORESETs may be an MBS service-specific configuration (i.e., mapping between MBs services and CORESETs). According to other example embodiments, for the configured CFR CORESET(s), depending on the UE capability, the UE may operate at the narrow configured CFR at a certain time stamp if the corresponding MBS service needs to be monitored and received, respectively. In certain example embodiments, if more than one MBS services are needed to be monitored and received by the MBS-UE at a certain time stamp, and the MBS services are configured in different narrow CFRs, the UE may operate as if its BWP is a larger bandwidth that covers multiple narrower CFRs. In some example embodiments, the switching operation by the UE from the initial BWP to the bandwidth of the narrow CFR may be transparent to the gNB.

According to certain example embodiments, with regard to Case E in the example of FIG. 1, the initial BWP may be confined within the MBS BWP/CFR that has a larger bandwidth, and the CFR_CORESET may be configured within the MBS BWP/CFR via MBS SIB or MCCH configuration. According to some example embodiments, the switching operation by the UE from the configured MBS BWP to the initial BWP may be transparent to the gNB, where the initial BWP may be considered as a CFR of the configured MBS BWP.

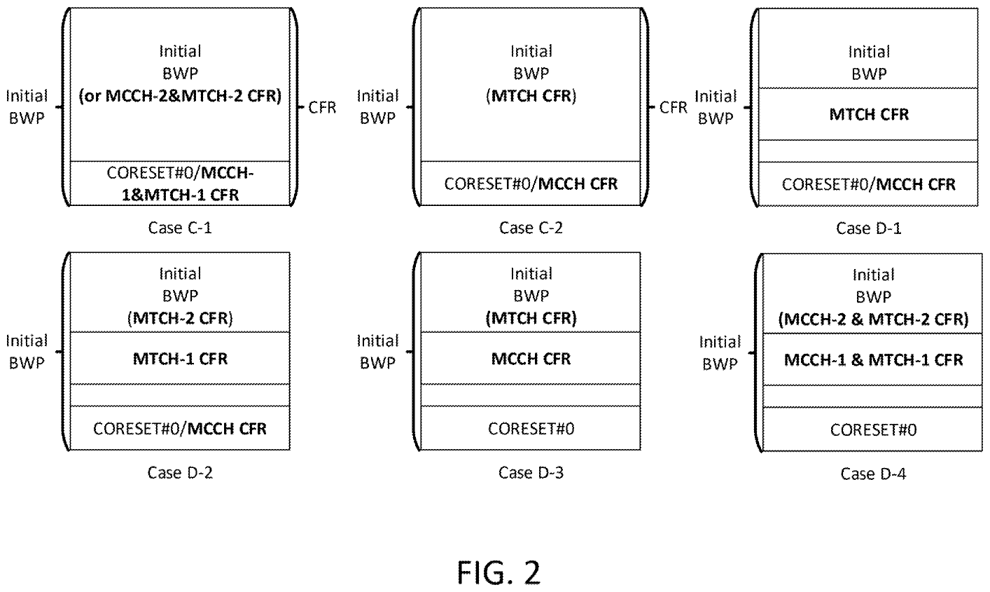

FIG. 2 illustrates an example CFR for MCCH and MTCH, according to certain example embodiments. According to certain example embodiments, the CFR configuration for MCCH and MTCH may be the same or different. In some example embodiments, the data payload size for MCCH and MTCH may differ significantly. For instance, the configuration information carried via MCCH may be smaller than the MBS service data payload carried via MTCH. Thus, different CFR configurations for MCCH and MTCH may be controlled by the network, as illustrated in the example of FIG. 2. Moreover, according to other example embodiments, if more than one MCCH is defined, different MCCHs (as well as different MTCHs corresponding to different MBS services) may also be configured with different CFR, as illustrated in the example of FIG. 2. Thus, according to certain example embodiments, if multiple MCCHs are supported, different MCCH CFRs may be configured respectively as shown in Case C-1/D-2 in the example of FIG. 2. In other example embodiments, if multiple MTCHs are supported, different MTCH CFRs may be configured respectively as shown in Case C-1/D-1/D-4 in the example of FIG. 2. In certain example embodiments, MCCH CFR and MTCH CFR may be configured differently as shown in Case C-2/D-1/D-3 in the example of FIG. 2. Additionally, in other example embodiments, the CFR of MCCH-1 and MTCH-1 corresponding to the same MBS services may be configured the same, but differently from the CFR of MCCH-2 and MTCH-2 corresponding to the other MBS services.

In certain example embodiments, by assuming and considering if the multiple CFRs and multiple MCCHs are supported, the gNB may also be allowed to configure separated/different CFR for multiple MCCH(s) and MTCH(s), as illustrated in the example of FIG. 2. In Case C-2/D-4 of FIG. 2, the CFR of MCCH-1 and MTCH-1 corresponding to the same MBS services may be configured to be the same, but different from the CFR of MCCH-2 and MTCH-2 corresponding to the other MBS services. Alternatively, in other example embodiments, as shown in Case D-3 in the example of FIG. 2, the same MCCH CFR may be configured for multiple MBS services, but differently from MTCH CFRs, which can be configured for different MBS services, respectively. However, by considering that the differentiation of multiple MCCHs may be in terms of monitoring periodically, a single common MCCH CFR may be enough to be considered. Whereas for MTCH, the traffic data size from different MBS services may vary significantly. Thus, separated/different CFRs in terms of MBS service types may be considered. In addition, according to certain example embodiments, different CFR configurations may be applied for MCCH and MTCH, where MCCH may be outside of the configured MTCH CFR. If multiple CFRs are supported, there may be a single MCCH CFR configured. However, in other example embodiments, there may be multiple MTCH CFRs configured corresponding to different MBS service types applied.

In certain example embodiments, with regard to Case E in the example of FIG. 1, similar CFR considerations may be applied. For instance, Case E-1 may be characterized by MCCH CFR with CORESET #0, MTCH-1 CFR with initial BWP, and MTCH-2 CFR with initial BWP. Further, Case-E-2 may be characterized by MCCH CFR with CORESET #0 or initial BWP, and MTCH CFR with configured MBS BWP only. In addition, Case E-3 may be characterized by MCCH CFR and MTCH-1 CFR with initial BWP, and MTCH-2 CFR with configured MBS BWP. Further, Case E-4 may be characterized by both MCCH and MTCH CFR, and with the configured MBS BWP.

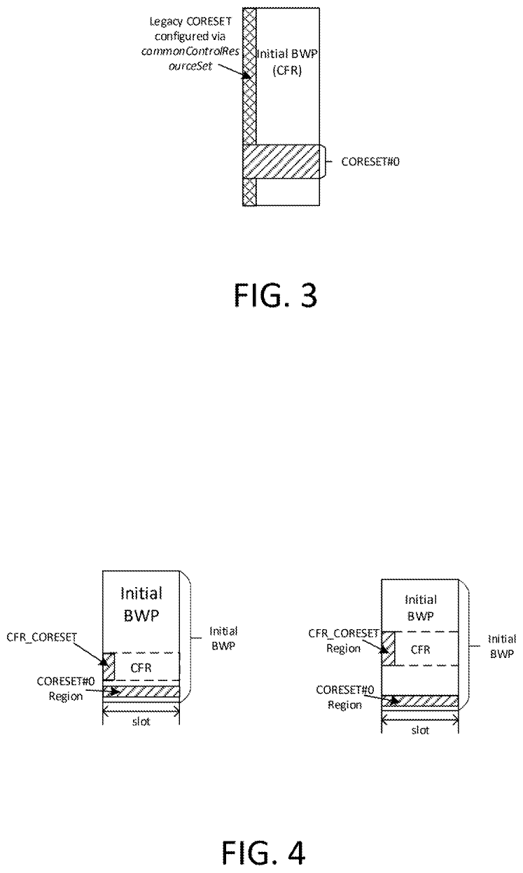

FIG. 3 illustrates an example of a gNB configuration of separated/different CFR for multiple MCCH(s) and MTCH(s), according to certain example embodiments. According to certain example embodiments, it may be possible to configure CORESET for MBS services for RRC_IDLE/INACTIVE UEs, and perform BWP operations. For instance, according to certain example embodiments, with regard to Case C in the example of FIG. 1, the group common PDCCH/PDSCH for MBS services may be monitored and received via CFR that is identical to the initial BWP. Further, in addition to CORESET #0 in the initial BWP, an additional commonControlResourceSet may be configured via SIB signaling, as illustrated in the example of FIG. 3. With this approach, the MBS UE may remain with the legacy limitation where the support of two CORESETs per BWP is mandatory (i.e., CORESET #0 and CORESET configured via commonControlResourceSet in the initial BWP. With this approach, for MBS UE behavior, there may be various implementations.

For instance, according to certain example embodiments, under the legacy approach, if the UE is configured with the CORESET via commonControlResourceSet for broadcast services, the UE may monitor broadcast services via the CORESET configured via commonControlResourceSet as well as CORESET #0. Otherwise, if the CORESET via commonControlResourceSet is not configured and the UE is configured with broadcast service reception, the UE may monitor the CORESET #0 for broadcast services as a default.

In certain example embodiments, if the UE is configured with the CORESET via commonControlResourceSet for certain broadcast service(s), the UE may monitor that specific broadcast service(s) via the CORESET configured via commonControlResourceSet. In addition, the UE may monitor other broadcast services via CORESET #0. Furthermore, in case of multiple broadcast services, the UE may be configured to monitor CORESET via commonControlResourceSet for some services, while monitoring CORESET #0 for other services.

According to certain example embodiments, the broadcast service with the CORESET configured via commonControlResourceSet may have a different monitoring occasion/reception cycle from the broadcast services that are monitored at CORSET #0 (i.e., the UE may frequently monitor a certain broadcast service with CORESET configured via commonControlResourceSet than the broadcast services monitored at CORESET #0). With such a configuration, the NR broadcast services may be configured and monitored by the UE both in the CORESET #0 and the CORESET configured via commonControlResourceSet. According to certain example embodiments, to have a mapping between broadcast service to one of the CORESETs, several methods, such as a new parameter in MBS service configuration or G-RNTI configuration may be individually used.

In other example embodiments, where MBS service to CORESET mapping is not used, frequent monitoring of a certain broadcast service via CORESET #0 may jeopardize the performance of legacy UEs from a power saving perspective. Instead, certain example embodiments may 1o provide a new SS configuration to the MBS UE via MBS SIB or MCCH. This SS may be located at CORESET #0 so that the legacy UEs and the UEs that are not interested in MBS services are not required to monitor CORESET #0 PDCCH with an increased frequency. Similarly, for CORESET configured via commonControlResourceSet, a new SS (i.e., mbsSearchSpace) may be configured via MBS SIB/MCCH specifically for MBS that enables a similar behavior. For instance, different monitoring occasion may be configured for the UEs receiving MBS service(s) than conventional monitoring occasions that are followed by the legacy UEs that also monitor the legacy commonControlResourceSet. According to certain example embodiments, mapping of the new SS with a certain broadcast service may be made by mbsSearchSpace configuration in the CORESET via MBS SIB or MCCH, where a searchSpaceId is linked with one or more G-RNTI(s) configuration, or different searchSpaceId is associated with different G-RNTI configuration. Otherwise, if the CORESET via commonControlResourceSet is not configured, the UE may monitor the CORESET #0 for broadcast services by default.

FIG. 4 illustrates an example CFR confined within an initial BWP, according to certain example embodiments. In certain example embodiments, with regard to Case D in the example of FIG. 1, the group-common PDCCH/PDSCH for MBS services may be monitored and received via a smaller CFR that is confined within the initial BWP, where in this case a new/additional CFR_CORESET (in addition to CORESET #0 and CORESET via commonControlResourceSet) is configured within the CFR (e.g., via MBS SIB or MCCH configuration), as illustrated in the example of FIG. 4.

According to certain example embodiments, if the legacy CORESET via commonControlResourceSet is not configured for the MBS UE, configurations by the gNB may still stick to the legacy limitation on support of two CORESETs per BWP (i.e., CORESET #0 and CFR_CORESET configured via a new CORESET configuration, such as, for example, commonControlResourceSet_CFR in the initial BWP).

Furthermore, in certain example embodiments, if the UE is configured with CFR_CORESET for a certain broadcast service, the UE may monitor that broadcast service via the CFR_CORESET configured via commonControlResourceSet_CFR. In addition, the UE may monitor other broadcast services via CORESET #0. In other example embodiments, the broadcast service with the CFR_CORESET may have a different monitoring/reception cycle from the broadcast service with CORESET #0. For example, the UE may need to more frequently monitor a certain broadcast service with CFR_CORESET than the broadcast service with CORESET #0. Therefore, in certain example embodiments, NR broadcast services may be configured and monitored by the UE both in the CORESET #0 as well as CFR_CORESET depending on the broadcast service types, as illustrated in the example of FIG. 4.

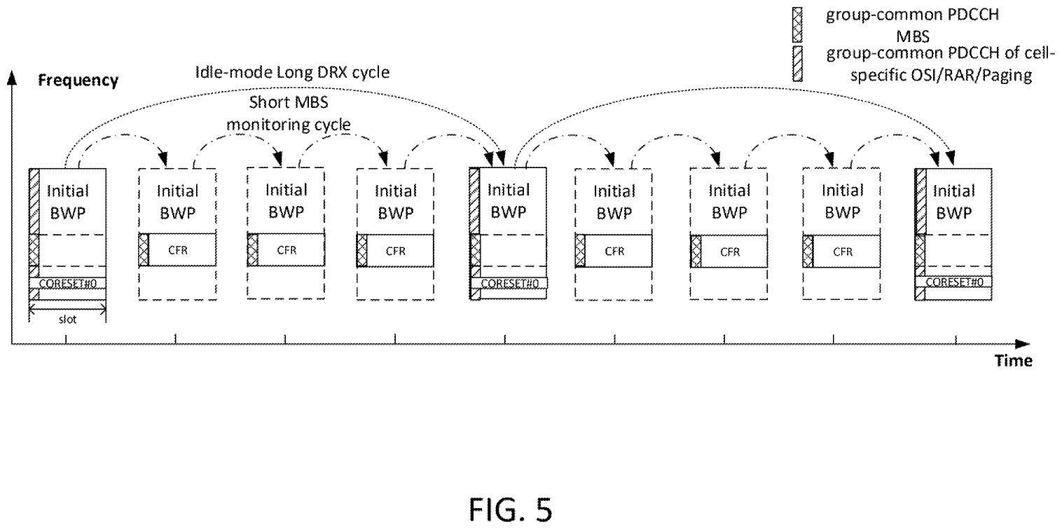

FIG. 5 illustrates an example narrow CFR bandwidth operation at a certain time stamp, according to certain example embodiments. As illustrated in the example of FIG. 5, depending on the UE capability, the UE may perform a narrow CFR bandwidth operation at a certain time stamp. The switching operation by UE from the bandwidth of initial BWP to the bandwidth of narrow CFR may be transparent to the gNB. Further, with CFR (Case D), depending on UE capability, the UE may operate with a configured “narrow CFR” at a certain time stamp for the benefit of power saving. According to certain example embodiments, the switching by the UE from the legacy initial BWP to the bandwidth of the narrow CFR may be transparent to the gNB. In other example embodiments, the UE may report its capability of supporting or not supporting this new kind of CFR switching. If supported, the gNB may configure the narrow CFR “frequency-range” to UE. As shown in the example of FIG. 5, the UE may perform a narrow CFR bandwidth operation at a certain time stamp. In addition, the switching operation by the UE from bandwidth of initial BWP to the bandwidth of narrow CFR (and vice-versa) may be transparent to the gNB. Otherwise, if the CFR_CORESET is not be configured, the UE may monitor the CORESET #0 for broadcast services.

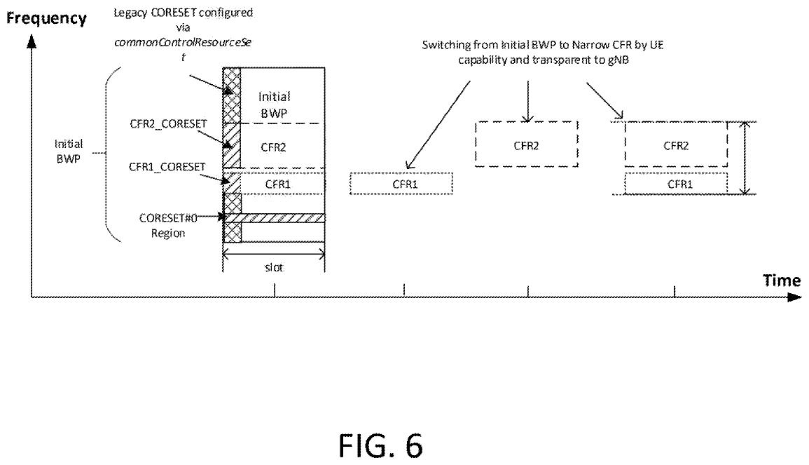

FIG. 6 illustrates the CFR configured within an initial BWP, according to certain example embodiments. In particular, in certain example embodiments, with regard to Case D in the example of FIG. 1, with CFR configured within the initial BWP, and based on the UE capability, there may be more than one PDCCH CORESTEs per BWP in addition to the CORESET #0 in the BWP, as illustrated in FIG. 6. For instance, according to certain example embodiments, the gNB configured CORESETs based on UE capability may be Case-A where CORESET #0, CFR_CORESET, as well as legacy CORESET may be configured via commonControlResourceSet. In addition, in Case-B, the gNB configured CORESETs based on UE capability may be CORESET #0, CFR1_CORESET, and CFR2_CORESET. Furthermore, in Case-C, the gNB configured CORESETs based on UE capability may be CORESET #0, CFR1_CORESET, CFR2_CORESET, as well as legacy CORESET configured via commonControlResourceSet.

According to certain example embodiments, the CORESET may be an MBS service-specific configuration for the UE to monitor. In addition, for the configured CFR CORESET(s), depending on UE capability, the UE may perform a narrow CFR bandwidth operation at a certain time stamp (e.g., as illustrated in the example of FIG. 5). The UE may also switch to a bandwidth of narrow CFR1 or CFR2 if the corresponding MBS service is to be monitored and received respectively. Further, if MBS services on both CFR1 and CFR2 are monitored and received, a larger bandwidth covering both CFR1 and CFR2 may be applied. In certain example embodiments, the switching operation by the UE between the initial BWP and the narrow CFRs may be transparent to the gNB.

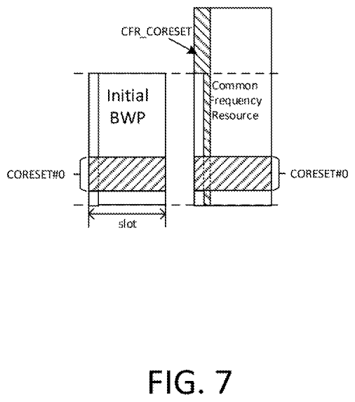

FIG. 7 illustrates an initial BWP confined within the CFR with larger bandwidth, according to certain example embodiments. Specifically, with regard to Case E in the example of FIG. 1, if the initial BWP is confined within the CFR with larger bandwidth, and CFR_CORESET is configured within the CFR, MBS UE may be configured with a larger CFR BWP than the initial BWP via MBS SIB or MCCH. In addition, the configured larger CFR may be considered as an independent MBS BWP in addition to the initial BWP. Furthermore, depending on UE capability, additional CFR_CORESET may be configured in the CFR BWP with wider bandwidth, as illustrated in FIG. 7.

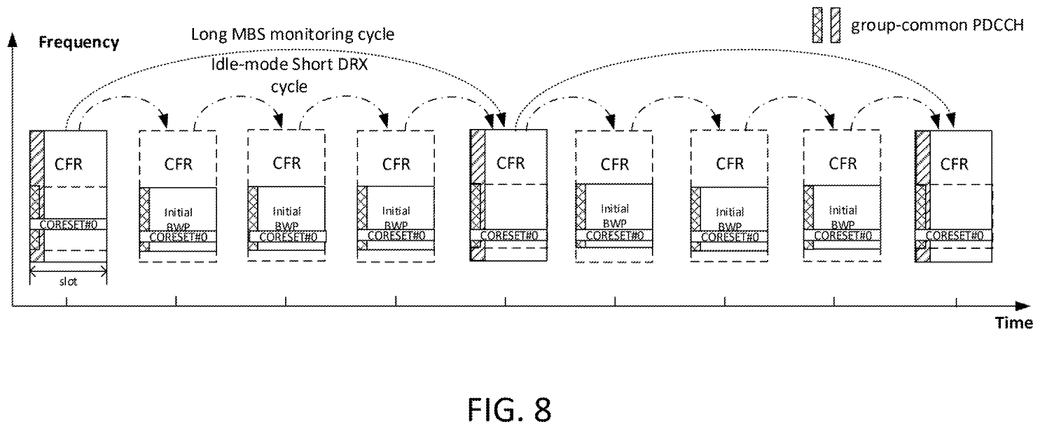

FIG. 8 illustrates an example bandwidth switch to narrow initial BWP, according to certain example embodiments. In particular, FIG. 8 illustrates the MBS UE may bandwidth switch to a narrow initial BWP at a certain time stamp for frequently monitoring transmitted paging/OSI/RAR information. According to certain example embodiments, instead of considering the initial BWP as an independent BWP, the initial BWP may be seen as a CFR of the configured MBS BWP, where the switching operation is similar to the case illustrated in the examples of FIGS. 5 and 6.

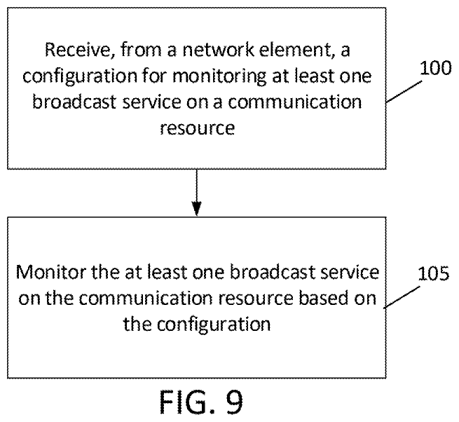

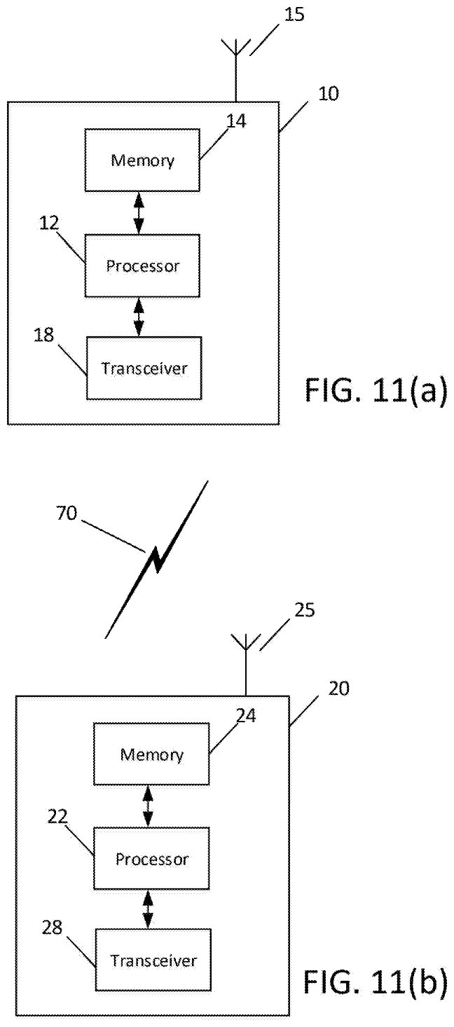

FIG. 9 illustrates an example flow diagram of a method, according to certain example embodiments. In an example embodiment, the method of FIG. 9 may be performed by a network entity, network node, or a group of multiple network elements in a 3GPP system, such as LTE or 5G-NR. For instance, in an example embodiment, the method of FIG. 9 may be performed by a UE, for instance, similar to apparatus 10 illustrated in FIG. 11(a) or 11(b).

According to certain example embodiments, the method of FIG. 9 may include, at 100, receiving, from a network element, a configuration for monitoring at least one broadcast services on a communication resource. The method may also include, at 105, monitoring the at least one broadcast service on the communication resource based on the configuration. According to certain example embodiments, the communication resource is a subset of an initial bandwidth part, or the communication resource may include an initial bandwidth part as a subset of the communication resource.

According to certain example embodiments, the communication resource may include a least one common frequency resource configured within an initial bandwidth part, or the communication resource may include a multicast broadcast service bandwidth part that comprises an initial bandwidth part. According to other example embodiments, the configuration for monitoring at least one broadcast service on a communication resource may include at least one of a control resource set configuration and a common frequency resource configuration. According to further example embodiments, monitoring at least one broadcast service on a communication resource may include monitoring two broadcast services and wherein each broadcast service is monitored on a different control resource set or common frequency resource.

In certain example embodiments, the method may also include switching between monitoring the at least one broadcast service on the initial bandwidth part and the common frequency resource, wherein the initial bandwidth part is monitored with a first monitoring cycle and the common frequency resource is monitored with a second monitoring cycle, or include switching between monitoring the at least one broadcast service on the common frequency resource and the initial bandwidth part. In some example embodiments, the common frequency resource may be monitored with a first monitoring cycle and the initial bandwidth part is monitored with a second monitoring cycle. In other example embodiments, the first monitoring cycle may be longer than the second monitoring cycle. In further example embodiments, the configuration for monitoring may be received via at least one of a multicast broadcast service system information block and a multicast control channel.

According to certain example embodiments, the method may also include receiving a configuration for monitoring a second at least one broadcast service, wherein the second at least one broadcast services may be monitored on a control resource set #0 or on an initial bandwidth part. According to other example embodiments, the method may also include monitoring the second at least one broadcast service based on the configuration. According to further example embodiments, the at least one broadcast service may be monitored during a radio resource control idle state or a radio resource control inactive state.

In certain example embodiments, the monitoring of the at least one broadcast service on the communication resource may be based on a capability of a user equipment. In other example embodiments, a control resource set may include a control resource set #0, a configured control resource set, or a configured control resource set dedicated to a common frequency resource. In some example embodiments, monitoring at least one broadcast service on a communication resource may include monitoring one broadcast service, and the one broadcast service may be monitored on a control resource set and a common frequency resource. In further example embodiments, configuration for monitoring at least one broadcast service on the communication resource may include at least one of a search-space and a monitoring occasion, and the at least one of a search-space and a monitoring occasion may be for a control resource set #0 or the initial bandwidth part.

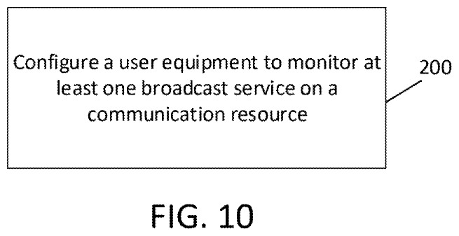

FIG. 10 illustrates an example flow diagram of another method, according to certain example embodiments. In an example embodiment, the method of FIG. 10 may be performed by a network entity, network node, or a group of multiple network elements in a 3GPP system, such as LTE or 5G-NR. For instance, in an example embodiment, the method of FIG. 10 may be performed by a BS, for instance, similar to apparatus 20 illustrated in FIG. 11(a) or 11(b).

According to certain example embodiments, the method of FIG. 9 may include, at 200, configuring a user equipment to monitor at least one broadcast service on a communication resource. According to other example embodiments, the communication resource may be a subset of an initial bandwidth part, or the communication resource may include an initial bandwidth part as a subset of the communication resource.

According to certain example embodiments, the communication resource may include a least one common frequency resource configured within an initial bandwidth part, or the communication resource may include a multicast broadcast service bandwidth part that comprises an initial bandwidth part. According to other example embodiments, the configuration for monitoring at least one broadcast service on a communication resource may include at least one of a control resource set configuration and a common frequency resource configuration. According to further example embodiments, the method may also include configuring the user equipment to monitor a second at least one broadcast service, wherein the second at least one broadcast services may be monitored on a control resource set #0 or on an initial bandwidth part.

In certain example embodiments, the user equipment may be configured via at least one of a multicast broadcast service system information block and a multicast control channel. In other example embodiments, the method may also include setting a communication resource configuration for the multicast control channel and multicast transport channel. In some example embodiments, the communication resource configuration comprises at least one of configuration of a different communication resource for each of the multicast control channel and the multicast transport channel, configuration of a single-common configured multicast control channel resource with a plurality of configured multicast transport channel resources, configuration of a plurality of configured multicast control channel resources with the plurality of configured multicast transport channel resources, and configuration of single-common communication resource with a corresponding common multicast control channel and a corresponding multicast transport channel.

According to certain example embodiments, the method may also include configuring a different common frequency resource for the multicast control channel and a multicast transport channel, or configuring a single common multicast control channel common frequency resource. According to other example embodiments, configuring the user equipment may include providing the user equipment with at least one of a search-space configuration and a monitoring occasion configuration. According to further example embodiments, the at least one of a search space configuration and a monitoring occasion may be for a control resource set #0 or the initial bandwidth part. In certain example embodiments, a control resource set may include a control resource set #0, a configured control resource set, or a configured control resource set dedicated to a common frequency resource. In certain example embodiments, the user equipment may configured to monitor two broadcast services, and the user equipment may be configured to monitor each broadcast service on a different control resource set or common frequency resource. In other example embodiments, the user equipment may be configured to monitor one broadcast service, and the user equipment may be configured to the broadcast service on a control resource set and a common frequency resource.

FIG. 11(a) illustrates an apparatus 10 according to certain example embodiments. In certain example embodiments, apparatus 10 may be a node or element in a communications network or associated with such a network, such as a UE, mobile equipment (ME), mobile station, mobile device, stationary device, or other similar device. It should be noted that one of ordinary skill in the art would understand that apparatus 10 may include components or features not shown in FIG. 11(a).

In some example embodiments, apparatus 10 may include one or more processors, one or more computer-readable storage medium (for example, memory, storage, or the like), one or more radio access components (for example, a modem, a transceiver, or the like), and/or a user interface. In some example embodiments, apparatus 10 may be configured to operate using one or more radio access technologies, such as GSM, LTE, LTE-A, NR, 5G, WLAN, WiFi, NB-IoT, Bluetooth, NFC, MulteFire, and/or any other radio access technologies. It should be noted that one of ordinary skill in the art would understand that apparatus 10 may include components or features not shown in FIG. 11(a).

As illustrated in the example of FIG. 11(a), apparatus 10 may include or be coupled to a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 12 is shown in FIG. 11(a), multiple processors may be utilized according to other example embodiments. For example, it should be understood that, in certain example embodiments, apparatus 10 may include two or more processors that may form a multiprocessor system (e.g., in this case processor 12 may represent a multiprocessor) that may support multiprocessing. According to certain example embodiments, the multiprocessor system may be tightly coupled or loosely coupled (e.g., to form a computer cluster).

Processor 12 may perform functions associated with the operation of apparatus 10 including, as some examples, precoding of antenna gain/phase parameters, encoding and decoding of individual bits forming a communication message, formatting of information, and overall control of the apparatus 10, including processes illustrated in FIGS. 1-9.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be comprised of any combination of random access memory (RAM), read only memory (ROM), static storage such as a magnetic or optical disk, hard disk drive (HDD), or any other type of non-transitory machine or computer readable media. The instructions stored in memory 14 may include program instructions or computer program code that, when executed by processor 12, enable the apparatus 10 to perform tasks as described herein.

In certain example embodiments, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10 to perform any of the methods illustrated in FIGS. 1-9.

In some example embodiments, apparatus 10 may also include or be coupled to one or more antennas 15 for receiving a downlink signal and for transmitting via an uplink from apparatus 10. Apparatus 10 may further include a transceiver 18 configured to transmit and receive information. The transceiver 18 may also include a radio interface (e.g., a modem) coupled to the antenna 15. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an uplink.

For instance, transceiver 18 may be configured to modulate information on to a carrier waveform for transmission by the antenna(s) and demodulate information received via the antenna(s) 15 for further processing by other elements of apparatus 10. In other example embodiments, transceiver 18 may be capable of transmitting and receiving signals or data directly. Additionally or alternatively, in some example embodiments, apparatus 10 may include an input and/or output device (I/O device). In certain example embodiments, apparatus 10 may further include a user interface, such as a graphical user interface or touchscreen.

In certain example embodiments, memory 14 stores software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software. According to certain example embodiments, apparatus 10 may optionally be configured to communicate with apparatus 20 via a wireless or wired communications link 70 according to any radio access technology, such as NR.

According to certain example embodiments, processor 12 and memory 14 may be included in or may form a part of processing circuitry or control circuitry. In addition, in some example embodiments, transceiver 18 may be included in or may form a part of transceiving circuitry.

For instance, in certain example embodiments, apparatus 10 may be controlled by memory 14 and processor 12 to receive, from a network element, a configuration for monitoring at least one broadcast services on a communication resource. Apparatus 10 may also be controlled by memory 14 and processor 12 to monitor the at least one broadcast service on the communication resource based on the configuration. According to certain example embodiments, the communication resource may be a subset of an initial bandwidth part, or the communication resource may include an initial bandwidth part as a subset of the communication resource.

FIG. 11(b) illustrates an apparatus 20 according to certain example embodiments. In certain example embodiments, the apparatus 20 may be a node or element in a communications network or associated with such a network, such as a base station, a Node B, an evolved Node B (eNB), 5G Node B or access point, next generation Node B (NG-NB or gNB), NM, BS, and/or WLAN access point, associated with a radio access network (RAN), such as an LTE network, 5G or NR. It should be noted that one of ordinary skill in the art would understand that apparatus 20 may include components or features not shown in FIG. 11(b).

As illustrated in the example of FIG. 11(b), apparatus 20 may include a processor 22 for processing information and executing instructions or operations. Processor 22 may be any type of general or specific purpose processor. For example, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 22 is shown in FIG. 11(b), multiple processors may be utilized according to other example embodiments. For example, it should be understood that, in certain example embodiments, apparatus 20 may include two or more processors that may form a multiprocessor system (e.g., in this case processor 22 may represent a multiprocessor) that may support multiprocessing. In certain example embodiments, the multiprocessor system may be tightly coupled or loosely coupled (e.g., to form a computer cluster).

According to certain example embodiments, processor 22 may perform functions associated with the operation of apparatus 20, which may include, for example, precoding of antenna gain/phase parameters, encoding and decoding of individual bits forming a communication message, formatting of information, and overall control of the apparatus 20, including processes illustrated in FIGS. 1-8 and 10.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can be comprised of any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In certain example embodiments, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20 to perform the methods illustrated in FIGS. 2. 1-8 and 10.

In certain example embodiments, apparatus 20 may also include or be coupled to one or more antennas 25 for transmitting and receiving signals and/or data to and from apparatus 20. Apparatus 20 may further include or be coupled to a transceiver 28 configured to transmit and receive information. The transceiver 28 may include, for example, a plurality of radio interfaces that may be coupled to the antenna(s) 25. The radio interfaces may correspond to a plurality of radio access technologies including one or more of GSM, NB-IoT, LTE, 5G, WLAN, Bluetooth, BT-LE, NFC, radio frequency identifier (RFID), ultrawideband (UWB), MulteFire, and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (for example, via an uplink).

As such, transceiver 28 may be configured to modulate information on to a carrier waveform for transmission by the antenna(s) and demodulate information received via the antenna(s) 25 for further processing by other elements of apparatus 20. In other example embodiments, transceiver 18 may be capable of transmitting and receiving signals or data directly. Additionally or alternatively, in some example embodiments, apparatus 20 may include an input and/or output device (I/O device).

In certain example embodiment, memory 24 may store software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software.

According to some example embodiments, processor 22 and memory 24 may be included in or may form a part of processing circuitry or control circuitry. In addition, in some example embodiments, transceiver 28 may be included in or may form a part of transceiving circuitry.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to cause an apparatus (e.g., apparatus 10 and 20) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

In other example embodiments, apparatus 20 may be controlled by memory 24 and processor 22 to configure a user equipment to monitor at least one broadcast service on a communication resource. According to other example embodiments, the communication resource may be a subset of an initial bandwidth part, or the communication resource may include an initial bandwidth part as a subset of the communication resource.

In some example embodiments, an apparatus (e.g., apparatus 10 and/or apparatus 20) may include means for performing a method, a process, or any of the variants discussed herein. Examples of the means may include one or more processors, memory, controllers, transmitters, receivers, and/or computer program code for causing the performance of the operations.

Certain example embodiments may be directed to an apparatus that includes means for receiving, from a network element, a configuration for monitoring at least one broadcast services on a communication resource. The apparatus may also include means for monitoring the at least one broadcast service on the communication resource based on the configuration. According to certain example embodiments, the communication resource may be a subset of an initial bandwidth part, or the communication resource may include an initial bandwidth part as a subset of the communication resource.

Other example embodiments may be directed to an apparatus that includes means for configuring a user equipment to monitor at least one broadcast service on a communication resource. According to other example embodiments, the communication resource may be a subset of an initial bandwidth part, or the communication resource may include an initial bandwidth part as a subset of the communication resource.

Certain example embodiments described herein provide several technical improvements, enhancements, and/or advantages. In some example embodiments, it may be possible to configure the CORESET for MBS services for RRC_IDLE/INACTIVE UEs. According to other example embodiments, it may be possible to provide CFR configuration for MCCH and MTCH, and configure separate/different CFRs for multiple MCCH(s) and MTCH(s). In further example embodiments, it may be possible for UEs to achieve power saving by switching from the initial BWP to the bandwidth of narrow CFR_CORESET where the operation with configured narrow CFR may occur at certain time stamps.

In some example embodiments, an apparatus may include or be associated with at least one software application, module, unit or entity configured as arithmetic operation(s), or as a program or portions of programs (including an added or updated software routine), which may be executed by at least one operation processor or controller. Programs, also called program products or computer programs, including software routines, applets and macros, may be stored in any apparatus-readable data storage medium and may include program instructions to perform particular tasks. A computer program product may include one or more computer-executable components which, when the program is run, are configured to carry out some example embodiments. The one or more computer-executable components may be at least one software code or portions of code. Modifications and configurations required for implementing the functionality of an example embodiment may be performed as routine(s), which may be implemented as added or updated software routine(s). In one example, software routine(s) may be downloaded into the apparatus.

As an example, software or a computer program code or portions of it may be in a source code form, object code form, or in some intermediate form, and it may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality may be performed by hardware or circuitry included in an apparatus (e.g., apparatus 10 or apparatus 20), for example through the use of an application specific integrated circuit (ASIC), a programmable gate array (PGA), a field programmable gate array (FPGA), or any other combination of hardware and software. In yet another example embodiment, the functionality may be implemented as a signal, a non-tangible means that can be carried by an electromagnetic signal downloaded from the Internet or other network.

According to certain example embodiments, an apparatus, such as a node, device, or a corresponding component, may be configured as circuitry, a computer or a microprocessor, such as single-chip computer element, or as a chipset, including at least a memory for providing storage capacity used for arithmetic operation and an operation processor for executing the arithmetic operation.

One having ordinary skill in the art will readily understand that the invention as discussed above may be practiced with procedures in a different order, and/or with hardware elements in configurations which are different than those which are disclosed. Therefore, although the invention has been described based upon these example embodiments, it would be apparent to those of skill in the art that certain modifications, variations, and alternative constructions would be apparent, while remaining within the spirit and scope of example embodiments. Although the above embodiments refer to 5G NR and LTE technology, the above embodiments may also apply to any other present or future 3GPP technology, such as LTE-advanced, and/or fourth generation (4G) technology.

### Partial Glossary

3GPP 3rd Generation Partnership Project

5G 5th Generation

5GCN 5G Core Network

BS Base Station

BWP Bandwidth Part

CFR Common Frequency Resource

CORESET Common Resource Set

DCI Downlink Control Information

eNB Enhanced Node B

gNB 5G or Next Generation NodeB

LTE Long Term Evolution

MBS Multicast Broadcast Service

NR New Radio

PDCCH Physical Downlink Control Channel

PTM Point to Multipoint

RAR Random Access Response

SIB System Information Block

SS Search Space

UE User Equipment

1-77. (canceled)

78. A method, comprising:
receiving, from a network element, a configuration for monitoring at least one broadcast service on a communication resource, wherein the configuration for monitoring is received via a multicast broadcast service system information block; and
monitoring the at least one broadcast service on the communication resource based on the configuration,
wherein the communication resource comprises at least one common frequency resource configured within an initial bandwidth part.

79. The method according to claim 78, wherein the configuration for monitoring at least one broadcast service on a communication resource comprises at least one of a control resource set configuration and a common frequency resource configuration.

80. The method according to claim 79, wherein monitoring at least one broadcast service on a communication resource comprises monitoring two broadcast services and wherein each broadcast service is monitored on a different control resource set or common frequency resource.

81. The method according to claim 79, further comprising:
switching between monitoring the at least one broadcast service on the initial bandwidth part and the common frequency resource, wherein the initial bandwidth part is monitored with a first monitoring cycle and the common frequency resource is monitored with a second monitoring cycle, or
switching between monitoring the at least one broadcast service on the common frequency resource and the initial bandwidth part, wherein the common frequency resource is monitored with a first monitoring cycle and the initial bandwidth part is monitored with a second monitoring cycle.

82. The method according to claim 81, wherein the first monitoring cycle is longer than the second monitoring cycle.

83. The method according to claim 78, further comprising:
receiving a configuration for monitoring a second at least one broadcast service, wherein the second at least one broadcast services is monitored on a control resource set #0 or on an initial bandwidth part; and
monitoring the second at least one broadcast service based on the configuration.

84. The method according to claim 78, wherein the at least one broadcast service is monitored during a radio resource control idle state or a radio resource control inactive state.

85. The method according to claim 78, wherein the monitoring of the at least one broadcast service on the communication resource is based on a capability of a user equipment.

86. An apparatus, comprising:
at least one processor; and
at least one memory comprising computer program code,
the at least one memory and the computer program code are configured, with the at least one processor, to cause the apparatus at least to:
receive, from a network element, a configuration for monitoring at least one broadcast service on a communication resource, wherein the configuration for monitoring is received via a multicast broadcast service system information block; and
monitor the at least one broadcast service on the communication resource based on the configuration,
wherein the communication resource comprises at least one common frequency resource configured within an initial bandwidth part.

87. The apparatus according to claim 86, wherein the configuration for monitoring at least one broadcast service on a communication resource comprises at least one of a control resource set configuration and a common frequency resource configuration.

88. The apparatus according to claim 87, wherein monitoring at least one broadcast service on a communication resource comprises monitoring two broadcast services and wherein each broadcast service is monitored on a different control resource set or common frequency resource.

89. The apparatus according to claim 87, wherein the at least one memory and the computer program code are further configured, with the at least one processor, to cause the apparatus at least to:
switch between monitoring the at least one broadcast service on the initial bandwidth part and the common frequency resource, wherein the initial bandwidth part is monitored with a first monitoring cycle and the common frequency resource is monitored with a second monitoring cycle, or
switch between monitoring the at least one broadcast service on the common frequency resource and the initial bandwidth part, wherein the common frequency resource is monitored with a first monitoring cycle and the initial bandwidth part is monitored with a second monitoring cycle.

90. The apparatus according to claim 89, wherein the first monitoring cycle is longer than the second monitoring cycle.

91. The apparatus according to claim 86, wherein the at least one memory and the computer program code are further configured, with the at least one processor, to cause the apparatus at least to:
receive a configuration for monitoring a second at least one broadcast service, wherein the second at least one broadcast services is monitored on a control resource set #0 or on an initial bandwidth part; and
monitor the second at least one broadcast service based on the configuration.

92. The apparatus according to claim 86, wherein the at least one broadcast service is monitored during a radio resource control idle state or a radio resource control inactive state.

93. The apparatus according to claim 86, wherein the at least one broadcast service is monitored on the communication resource based on a capability of the apparatus.

94. The apparatus according to claim 86, wherein a control resource set comprises a control resource set #0, a configured control resource set, or a configured control resource set dedicated to a common frequency resource.

95. The apparatus according to claim 86,
wherein monitoring at least one broadcast service on a communication resource comprises monitoring one broadcast service, and
wherein the one broadcast service is monitored on a control resource set and a common frequency resource.

96. The apparatus according to claim 86,
wherein configuration for monitoring at least one broadcast service on the communication resource comprises at least one of a search-space and a monitoring occasion, and
wherein the at least one of a search-space and a monitoring occasion is for a control resource set #0 or the initial bandwidth part.

97. An apparatus, comprising:
at least one processor; and
at least one memory comprising computer program code,
the at least one memory and the computer program code are configured, with the at least one processor, to cause the apparatus at least to:
configure a user equipment to monitor at least one broadcast service on a communication resource, wherein a configuration for monitoring is sent via a multicast broadcast service system information block, and
wherein the communication resource comprises at least one common frequency resource configured within an initial bandwidth part.
